(19) United States
(12) Patent Application Publication
(10) Pub. No.: US 2006/0001830 A1
(43) Pub. Date: Jan. 5, 2006

(54) Method for designing aspheric spectacle lens

(75) Inventor: Wen-Hsin Sun, Tu-cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD, Tu-cheng City (TW)

(21) Appl. No.: 11/174,155

(22) Filed: Jul. 1, 2005

(30) Foreign Application Priority Data
Jul. 5, 2004 (CN) 200410028020.6

(51) Int. Cl. G02C 7/02

(52) U.S. Cl. 351/177

(57) ABSTRACT

A method for designing an aspheric spectacle lens includes: designing a spherical spectacle lens, the spherical spectacle lens having a first surface being substantially flat, and a second surface being spherical and having a predetermined lens power; and correcting aberration of the spherical spectacle lens by changing the second surface into an aspheric surface. The second step includes: defining an aspheric surface by an aspheric-surface function, parameters of the function including a conic constant and at least one aspheric-surface coefficient; defining a merit function, the merit function having a parameter of inflection point, the parameter of inflection point being described with the conic constant and the aspheric-surface coefficient of the aspheric-surface function; and calculating a resolution of the merit function by a damped least square method.

### FIELD OF THE INVENTION

The present invention relates to spectacle lens design methods, and particularly to a method for designing an aspheric spectacle lens.

### BACKGROUND

Most conventional spectacle lenses are produced with an emphasis on ease of manufacture. Accordingly, in general, both of first and second surfaces of a typical spectacle lens have spherical shapes. Theoretically, for an infinitely thin lens, a spherical curvature is ideal for sharply focusing light passing through the lens. However, the curvatures and thickness of a normal lens produce well-known optical aberrations, which include spherical aberration, coma, distortion, and astigmatism. That is, light from a point source passing through different areas of the lens does not focus at a single point. This causes a certain amount of blurring. In addition, in the case of a spherical spectacle lens for correcting hyperopia, the thickness of the lens, particularly the central thickness of the lens, increases rapidly with an increase in the lens power of the lens. Similarly, in the case of a spherical spectacle lens for correcting myopia, the thickness of the lens, particularly the edge thickness of the lens, increases rapidly with an increase in the lens power of the lens. This is undesirable from the viewpoint of the external aesthetic appearance of such spherical spectacle lenses.

To solve the above-described problems, some aspheric spectacle lenses have been developed. At least one surface of such an aspheric spectacle lens is formed to have an aspheric shape. The aspheric spectacle lens has a thickness less than that of a spherical spectacle lens having the same lens power, and has reduced optical aberrations. However, a conventional aspheric lens almost invariably has inflection points, which cause much difficulty in manufacturing.

What is needed, therefore, is an aspheric spectacle lens design method which yields an aspheric spectacle lens without inflection points.

### SUMMARY

A method for designing an aspheric spectacle lens includes the following steps: designing a spherical spectacle lens, the spherical spectacle lens having a first surface being substantially flat, and a second surface being spherical and having a predetermined lens power; and correcting aberration of the spherical spectacle lens by changing the second surface into an aspheric surface. The second step includes: defining an aspheric surface by an aspheric-surface function, parameters of the function including a conic constant and at least one aspheric-surface coefficient; defining a merit function, the merit function having a parameter of inflection point, the parameter of inflection point being described with the conic constant and the aspheric-surface coefficient of the aspheric-surface function; and calculating a resolution of the merit function by a damped least square method.

Other advantages and novel features will become more apparent from the following detailed description.

### DETAILED DESCRIPTION OF PREFERRED EMBODIMENT

An aspheric spectacle lens design method of a preferred embodiment according to the present invention is used with software simulation techniques. The method includes the following steps: A. Designing a spherical spectacle lens; and B. Correcting aberration of the spherical spectacle lens by changing the second surface into an aspheric surface.

In step A., the spherical spectacle lens has two surfaces: a first surface which is farthest from the wearer's eye, and a second surface which is nearest to the wearer's eye. The first surface is substantially flat; i.e., a radius of curvature R₁ of the first surface is infinite. The spectacle lens is made of PC (polycarbonate), which has a refractive index n designated as n=1.586. The spectacle lens has a lens power Fᵥ designated as Fᵥ=−6D (Diopter), a diameter D_{A} designated as D_{A}=75 mm, and a central thickness t designated as t=1 mm. A radius of curvature R₂ of the second surface is determined by the following equations:

$$\begin{matrix}{F}_{1} = ( n - 1 ) / {R}_{1} \\ {F}_{2} = ( 1 - n ) / {R}_{2} \\ {F}_{V} = \frac{{F}_{1} + {F}_{2} - \frac{t}{n} {F}_{1} {F}_{2}}{1 - \frac{t}{n} {F}_{1}}\end{matrix}$$

where F₁ is a refractive power of the first surface, and F₂ is a refractive power of the second surface.

Step B. includes the following steps:

1. Defining an aspheric surface by an aspheric-surface function. The aspheric-surface function in the present embodiment is:

$$Z = \frac{{c}_{v} {r}^{2}}{1 + \sqrt{1 - {Pc}_{v}^{2} {r}^{2}}} + {Br}^{4} + {Cr}^{6} + {Dr}^{8} + {Er}^{10}$$

where Z is a length of a perpendicular dropped or drawn from a point, which is positioned on the aspheric surface and is located at a distance r from an optical axis, to a meridian plane, which contacts the aspheric surface at a vertex thereof; cᵥ is a curvature at the vertex of the aspheric surface; P is the conic constant, and B, C, D and E are aspheric-surface coefficients.

2. Defining a merit function. The merit function in the present embodiment is:

$$\begin{matrix}Φ = {\sum }_{i = 1}^{m} {[ {W}_{i} ( {e}_{i} - {t}_{i} ) ]}^{2} = {\sum }_{i = 1}^{m} {f}_{i}^{2} \\ {f}_{i} = {W}_{i} ( {e}_{i} - {t}_{i} )\end{matrix}$$

where Wᵢ is a weighted factor, whose value is related to eᵢ; eᵢ is one of the aberrations of the aspheric spectacle lens; tᵢ is a target value of eᵢ; and m is a number of the aberrations.

In the present embodiment, an astigmatism in 0.5 field of view is designated as e₁, an astigmatism in 0.7 field of view is designated as e₂, an astigmatism in 1.0 field of view is designated as e₃, a distortion is designated as e₄, and an inflection point is designated as e₅. The 1.0 field of view is defined as a field of view where input light beams irradiate to the wearer's eye over an angle of 30 degrees. Similarly, the 0.5 field of view is defined as a field of view where input light beams irradiate to the eye over an angle of 0.5*30=15 degrees, and the 0.7 field of view is defined as a field of view where input light beams irradiate to the eye over an angle of 0.7*30=21 degrees. Φ is now represented as the following function:
ΦW₁²(e₁−t₁)²+W₂²(e₂−t₂)²+W₃²(e₃−t₃)²+W₄²(e₄−t₄)²+W₅²(e₅−t₅)²
wherein e₁, e₂ , e₃ , e₄ and e₅ can be described with the conic constant P, and with the aspheric-surface coefficients B, C, D and E, so Φ can be described with parameters (P, B, C, D, E).

3. Calculating the solution of the merit function by a damped least square method. The solution of the damped least square method is according to the following equation:

$$\begin{matrix}X = - {( {A}^{T} A + QI )}^{- 1} {A}^{T} {f}_{0} \\ {A}_{ij} = \frac{\partial {f}_{i}}{\partial {x}_{j}} \\ x = {x}_{0} + X\end{matrix}$$

where A^{T} is a transpose matrix of A; Q is a damped factor; I is a unitary matrix; and (A^{T}A+QI)⁻¹ is an inverse matrix of (A^{T}A+QI). In the present embodiment, i and j are integers from 1 to 5; A is a 5*5 matrix; W₁=W₂=W₃=W₄=W₅=1, and t₁=t₂=t₃=t₄=t₅=0. The original values of P, B, C, D and E are represented as x₀=(x₁₀, x₂₀, x₃₀, x₄₀, x₅₀) and are determined by the second spherical surface of the spherical spectacle lens. The solutions of P, B, C, D and E are represented as x=(x₁, x₂, x₃, x₄, x₅). The original values of e₁, e₂, e₃, e₄ and e₅ are represented as f₀=(f₁₀, f₂₀, f₃₀, f₄₀, f₅₀).

TABLE 1 shows parameters of a typical aspheric spectacle lens obtained according to the present embodiment, when the lens powers is −6D. TABLES 2-4 show parameters of other aspheric spectacle lenses obtained according to the present embodiment, when the lens powers are −5D, −7D and −8D respectively. Further, each of TABLES 1-4 show differences between the aspheric spectacle lens obtained according to the present embodiment and a conventional spherical spectacle lens having the same lens power, diameter and central thickness.

Referring to TABLE 1, compared to the spherical spectacle lens, the edge thickness of the aspheric spectacle lens is reduced by 32%, the axial height of the aspheric spectacle lens is reduced by 59%, and the mass of the aspheric spectacle lens is reduced by 20%.

TABLE 1

| | Aspheric Spectacle | | Spherical Spectacle | |
|---|---|---|---|---|
| Parameter | Lens | | Lens | |
| Lens Power: | −6D | | | |
| Diameter: | 75 mm | | | |
| First Curvature | 10⁸ | mm | 122.878 | mm |
| Radius: | | | | |
| Second Curvature | 97.6667 | mm | 54.343 | mm |
| Radius: | | | | |
| Conic Constant P: | −2.8777 | | | |
| Aspheric-surface | B: −4.0545 × 10⁻⁷ | | | |
| Coefficient: | C: 1.6837 × 10⁻¹⁰ | | | |
| | D: −9.4327 × 10⁻¹⁴ | | | |
| | E: 1.572 × 10⁻¹⁸ | | | |
| Central thickness: | 1 | mm | 1 | mm |
| Edge Thickness: | 6.948 | mm | 10.150 | mm |
| Axial Height: | 6.948 | mm | 16.012 | mm |
| Astigmatism: | 0 | | 0 | |
| Refractive Power | 0.269 | | 0.245 | |
| Error: | | | | |
| Distortion: | −7.500% | | −6.047% | |
| Mass: | 23.023 | g | 28.705 | g |

Referring to TABLE 2, compared to the spherical spectacle lens, the edge thickness of the aspheric spectacle lens is reduced by 32%, the axial height of the aspheric spectacle lens is reduced by 62%, and the mass of the aspheric spectacle lens is reduced by 20%.

TABLE 2

| | Aspheric Spectacle | | Spherical Spectacle | |
|---|---|---|---|---|
| Parameter | Lens | | Lens | |
| Lens Power: | −5D | | | |
| Diameter: | 75 mm | | | |
| First Curvature | 10⁸ | mm | 108.936 | mm |
| Radius: | | | | |
| Second Curvature | 117.2 | mm | 56.359 | mm |
| Radius: | | | | |
| Conic Constant P: | −4.7315 | | | |
| Aspheric-surface | B: −4.2120 × 10⁻⁷ | | | |
| Coefficient: | C: 1.7608 × 10⁻¹⁰ | | | |
| | D: −7.0909 × 10⁻¹⁴ | | | |
| | E: 8.4856 × 10⁻¹⁸ | | | |
| Central thickness: | 1 | mm | 1 | mm |
| Edge Thickness: | 5.834 | mm | 8.629 | mm |
| Axial Height: | 5.834 | mm | 15.287 | mm |
| Astigmatism: | 0 | | 0 | |
| Refractive Power | 0.235 | | 0.212 | |
| Error: | | | | |
| Distortion: | −6.224% | | −4.863% | |
| Mass: | 19.826 | g | 24.871 | g |

Referring to TABLE 3, compared to the spherical spectacle lens, the edge thickness of the aspheric spectacle lens is reduced by 30%, the axial height of the aspheric spectacle lens is reduced by 51 %, and the mass of the aspheric spectacle lens is reduced by 19%.

TABLE 3

| | Aspheric Spectacle | | Spherical Spectacle | |
|---|---|---|---|---|
| Parameter | Lens | | Lens | |
| Lens Power: | −7D | | | |
| Diameter: | 75 mm | | | |
| First Curvature | 10⁸ | mm | 139.425 | mm |
| Radius: | | | | |
| Second Curvature | 83.7143 | mm | 52.255 | mm |
| Radius: | | | | |
| Conic Constant P: | −1.1445 | | | |
| Aspheric-surface | B: −4.829 × 10⁻⁷ | | | |
| Coefficient: | C: 1.2762 × 10⁻¹⁰ | | | |
| | D: −2.767 × 10⁻¹⁴ | | | |
| | E: −1.098 × 10⁻¹⁸ | | | |
| Central thickness: | 1 | mm | 1 | mm |
| Edge Thickness: | 8.196 | mm | 11.726 | mm |
| Axial Height: | 8.196 | mm | 16.863 | mm |
| Astigmatism: | 0 | | 0 | |
| Refractive Power | 0.296 | | 0.275 | |
| Error: | | | | |
| Distortion: | −8.793% | | −7.282% | |
| Mass: | 26.502 | g | 32.614 | g |

Referring to TABLE 4, compared to the spherical spectacle lens, the edge thickness of the aspheric spectacle lens is reduced by 29%, the axial height of the aspheric spectacle lens is reduced by 50%, and the mass of the aspheric spectacle lens is reduced by 18%.

TABLE 4

| | Aspheric Spectacle | | Spherical Spectacle | |
|---|---|---|---|---|
| Parameter | Lens | | Lens | |
| Lens Power: | −8D | | | |
| Diameter: | 75 mm | | | |
| First Curvature | 10⁸ | mm | 159.388 | mm |
| Radius: | | | | |
| Second Curvature | 73.25 | mm | 50.149 | mm |
| Radius: | | | | |
| Conic Constant P: | −0.3882 | | | |
| Aspheric-surface | B: −4.9137 × 10⁻⁷ | | | |
| Coefficient: | C: 9.089 × 10⁻¹⁰ | | | |
| | D: −4.8032 × 10⁻¹⁴ | | | |
| | E: −2.3177 × 10⁻¹⁸ | | | |
| Central thickness: | 1 | mm | 1 | mm |
| Edge Thickness: | 9.501 | mm | 13.378 | mm |
| Axial Height: | 9.501 | mm | 17.852 | mm |
| Astigmatism: | 0 | | 0 | |
| Refractive Power | 0.319 | | 0.300 | |
| Error: | | | | |
| Distortion: | −10.096% | | −8.565% | |
| Mass: | 30.016 | g | 36.626 | g |

It is to be understood, however, that even though numerous characteristics and advantages of the preferred embodiment have been set forth in the foregoing description, together with details of the structure and function of the preferred embodiment, the disclosure is illustrative only, and changes may be made in detail, especially in matters of shape, size, and arrangement of parts within the principles of the invention to the full extent indicated by the broad general meaning of the terms in which the appended claims are expressed.

I claim:

1. A method for designing an aspheric spectacle lens, comprising the steps of:
designing a spherical spectacle lens, the spherical spectacle lens having a first surface being substantially flat, and a second surface being spherical and having a predetermined lens power; and
correcting aberration of the spherical spectacle lens by changing the second surface into an aspheric surface, comprising the following steps:
defining the aspheric surface by an aspheric-surface function, parameters of the function comprising a conic constant and at least one aspheric-surface coefficient;
defining a merit function, the merit function having a parameter of inflection point, the parameter of inflection point being described with the conic constant and the aspheric-surface coefficient of the aspheric-surface function; and
calculating a solution of the merit function by a damped least square method.

2. The method as claimed in claim 1, wherein the aspheric-surface function is:
$$Z = \frac{{c}_{v} {r}^{2}}{1 + \sqrt{1 - {Pc}_{v}^{2} {r}^{2}}} + {Br}^{4} + {Cr}^{6} + {Dr}^{8} + {Er}^{10}$$
where Z is a length of a perpendicular dropped or drawn from a point, which is positioned on the aspheric surface and is located at a distance r from an optical axis, to a meridian plane, which contacts the aspheric surface at a vertex thereof; cᵥ is a curvature at the vertex of the aspheric surface; P is the conic constant, and B, C, D and E are aspheric-surface coefficients.

3. The method as claimed in claim 1, wherein the merit function further comprises parameters of astigmatism and distortion.

4. A method for designing an aspheric lens to be manufactured, comprising the steps of:
defining a spherical lens;
modifying at least one surface of said spherical lens by means of weighing aberration factors including at least one factor of inflection points defined on said at least one surface; and
designing said aspheric lens to have said modified at least one surface.

5. The method as claimed in claim 4, wherein said at least one surface is modified by using an aspheric-surface function of:
$$Z = \frac{{c}_{v} {r}^{2}}{1 + \sqrt{1 - {Pc}_{v}^{2} {r}^{2}}} + {Br}^{4} + {Cr}^{6} + {Dr}^{8} + {Er}^{10}$$
wherein Z is a length from a point on said modified at least one surface at a distance r from an optical axis to a meridian plane extending through an vertex of said at least one surface, cᵥ is a curvature at said vertex of said at least one surface, P is a conic constant, and B, C, D and E are aspheric-surface coefficients weighable due to said aberration factors.

6. The method as claimed in claim 4, wherein said aberration factors are weighed by using a merit function of:
$$\begin{matrix}Φ = {\sum }_{i = 1}^{m} {[ {W}_{i} ( {e}_{i} - {t}_{i} ) ]}^{2} = {\sum }_{i = 1}^{m} {f}_{i}^{2} \\ {f}_{i} = {W}_{i} ( {e}_{i} - {t}_{i} )\end{matrix}$$
wherein W₁ is a weighted factor related to eᵢ, eᵢ is one of said aberration factors for said aspheric lens, tᵢ is a target value of eᵢ, and m is a number of said aberration factors.

7. The method as claimed in claim 4, wherein said spherical lens is defined by using equations of:
$$\begin{matrix}{F}_{1} = ( n - 1 ) / {R}_{1} \\ {F}_{2} = ( 1 - n ) / {R}_{2} \\ {F}_{V} = \frac{{F}_{1} + {F}_{2} - \frac{t}{n} {F}_{1} {F}_{2}}{1 - \frac{t}{n} {F}_{1}}\end{matrix}$$
wherein F₁ is a refractive power of an first surface of said spherical lens, F₂ is a refractive power of a second surface of said spherical lens, Rᵢ is a radius of curvature of said first surface, R₂ is a radius of curvature of said second surface, t is a central thickness of said spherical lens and n is a refractive index of said spherical lens.

8. A method for designing an aspheric lens to be manufactured, comprising the steps of:
defining a spherical lens;
modifying at least one surface of said spherical lens by using a function of;
$$Z = \frac{{c}_{v} {r}^{2}}{1 + \sqrt{1 - {Pc}_{v}^{2} {r}^{2}}} + {Br}^{4} + {Cr}^{6} + {Dr}^{8} + {Er}^{10}$$
wherein Z is a length from a point on said modified at least one surface at a distance r from an optical axis to a meridian plane extending through an vertex of said at least one surface, cᵥ is a curvature at said vertex of said at least one surface, P is a conic constant, and B, C, D and E are aspheric-surface coefficients; and
weighing aberration factors including at least one factor of inflection points defined on said at least one surface within said function so as to acquire said aspheric lens having said modified at least one surface.
